(19) United States
(12) Patent Application Publication
(10) Pub. No.: US 2026/0035206 A1
(43) Pub. Date: Feb. 5, 2026

(54) SYSTEM AND METHOD FOR ASSISTING A PASSENGER DETECTED AT AN ELEVATOR BANK

(71) Applicant: OTIS ELEVATOR COMPANY, Farmington, CT (US)

(72) Inventors: Christine Vanek, Chicago, IL (US); Camilo Cardona, Middletown, CT (US); Kayla Geer, Richmond, VA (US); Kathleen Nicole Moore, West Hartford, CT (US); James Tilsley Auxier, Palm Beach Gardens,, FL (US); Michelle Swindell, Farmington, CT (US)

(21) Appl. No.: 18/792,052

(22) Filed: Aug. 1, 2024

(51) Int. Cl. B66B 3/00; B66B 1/46; B66B 13/14

(52) U.S. Cl. CPC B66B 3/002; B66B 1/468; B66B 13/143

(57) ABSTRACT

An elevator system, having: a call station located in a lobby; a device controller; a proximity sensor, operationally coupled to the device controller, located in the lobby, and configured to generate proximity sensor data utilized by the device controller, a speaker, operationally coupled to the device controller, and located in the lobby, wherein the device controller, from the proximity sensor data, is configured to: detect the presence of a passenger; determine the passenger requires assistance to locate the call station in the lobby; and issue an audible sound from the speaker to guide the passenger to the call station.

### BACKGROUND

The embodiments described herein relate to a passenger conveyor system, such as elevators, escalators, moving walkways, and other automated people movers, and more specifically to a system and method for assisting a passenger detected at an elevator bank.

Calling an elevator car to a lobby may require engaging an elevator call station within the lobby that is adjacent to an elevator bank. For individuals with disabilities affecting their eyesight (blind, low vision), finding an elevator call station at the elevator bank may be challenging.

### BRIEF SUMMARY

Disclosed is an elevator system, including: a call station located in a lobby; a device controller; a proximity sensor, operationally coupled to the device controller, located in the lobby, and configured to generate proximity sensor data utilized by the device controller, a speaker, operationally coupled to the device controller, and located in the lobby, wherein the device controller, from the proximity sensor data, is configured to: detect the presence of a passenger; determine the passenger requires assistance to locate the call station in the lobby; and issue an audible sound from the speaker to guide the passenger to the call station.

In addition to one or more aspects of the system or as an alternate, the system is configured to detect the passenger moving to an elevator car at the lobby, and to control the elevator car to remain at the lobby, with elevator doors opened until the passenger has boarded the elevator car.

In addition to one or more aspects of the system or as an alternate, the call station includes the device controller, the proximity sensor and the speaker.

The In addition to one or more aspects of the system or as an alternate, the proximity sensor is one or more of: a video proximity sensor; a motion detector; LIDAR; or RADAR.

In addition to one or more aspects of the system or as an alternate, the device controller is configured to: compare the proximity sensor data with prerecorded proximity sensor data to identify characteristics of the passenger, including implements accompanying the passenger, to determine the passenger requires assistance to locate the call station in the lobby.

In addition to one or more aspects of the system or as an alternate, the device controller is configured to: apply the proximity sensor data to a trained machine learning model, to identify characteristics of the passenger, including implements accompanying the passenger, to determine the passenger requires assistance to locate the call station in the lobby.

In addition to one or more aspects of the system or as an alternate, the device controller, with the proximity sensor data, is configured to determine the passenger requires assistance to locate the call station in the lobby by: identifying characteristics of a guide dog with the passenger; and/or identifying characteristics of a walking cane with the passenger.

In addition to one or more aspects of the system or as an alternate, the device controller, with the proximity sensor data, is configured to identify characteristics of the passenger loitering in the lobby and thereby determine the passenger requires assistance to locate the call station in the lobby.

In addition to one or more aspects of the system or as an alternate, the device controller, with the proximity sensor data, is configured to determine the passenger is loitering in the lobby by: determining the passenger is moving within the lobby at a speed below a threshold; or determine the passenger is moving along one or more predetermined paths near the call station without utilizing the call station.

In addition to one or more aspects of the system or as an alternate, the audible sound includes: verbal directions to the call station relative to a current location of the passenger; and/or a ping that increases in one or more of magnitude and frequency as the passenger moves closer to the call station.

Disclosed is a method of controlling an elevator system, including: detecting, by a device controller that receives proximity sensor data from a proximity sensor, which is operationally coupled to the device controller and located in a lobby, the presence of a passenger; determining, by the device controller, the passenger requires assistance to locate a call station in the lobby; and issuing, by a speaker, which is operationally coupled to the device controller and located in the lobby, an audible sound to guide the passenger to the call station.

In addition to one or more aspects of the method or as an alternate, the method includes the system detecting the passenger moving to an elevator car at the lobby, and controlling the elevator car to remain at the lobby, with elevator doors opened until the passenger has boarded the elevator car.

In addition to one or more aspects of the method or as an alternate, the call station includes the device controller, the proximity sensor and the speaker.

In addition to one or more aspects of the method or as an alternate, the proximity sensor is one or more of: a video proximity sensor; a motion detector; LIDAR; or RADAR.

In addition to one or more aspects of the method or as an alternate, when determining the passenger requires assistance to locate the call station in the lobby, the method includes: comparing, by the device controller, the proximity sensor data with prerecorded proximity sensor data to identify characteristics of the passenger, including implements accompanying the passenger.

In addition to one or more aspects of the method or as an alternate, when determining the passenger requires assistance to locate the call station in the lobby, the method includes: applying, by the device controller, the proximity sensor data to a trained machine learning model, to identify characteristics of the passenger, including implements accompanying the passenger, to determine the passenger requires assistance to locate the call station in the lobby.

In addition to one or more aspects of the method or as an alternate, when determining the passenger requires assistance to locate the call station in the lobby, the method includes: identifying, by the device controller from the proximity sensor data, characteristics of a guide dog with the passenger; and/or identifying, by the device controller from the proximity sensor data, characteristics of a walking cane with the passenger.

In addition to one or more aspects of the method or as an alternate, when determining the passenger requires assistance to locate the call station in the lobby, the method includes: identifying, by the device controller from the proximity sensor data, characteristics of the passenger loitering in the lobby.

In addition to one or more aspects of the method or as an alternate, when determining the passenger is loitering in the lobby, the method includes: determining, by the device controller from the proximity sensor data, that the passenger is moving within the lobby at a speed below a threshold; or determining, by the device controller from the proximity sensor data, that the passenger is moving along one or more predetermined patterns near the call station without utilizing the call station.

In addition to one or more aspects of the method or as an alternate, when issuing the audible sound to guide the passenger to the call station, the method includes: issuing, by the speaker, verbal directions to the call station relative to a current location of the passenger; and/or issuing, by the speaker, a ping that increases in one or more of magnitude and frequency as the passenger moves closer to the call station.

### BRIEF DESCRIPTION OF THE DRAWINGS

The present disclosure is illustrated by way of example and not limited to the accompanying figures in which like reference numerals indicate similar elements.

FIG. 1 is a schematic illustration of a passenger conveyor system, and in particular an elevator system, which may employ various embodiments of the present disclosure;

FIG. 2 shows additional aspects of the system of FIG. 1; and

FIG. 3 shows a method of controlling an elevator system.

### DETAILED DESCRIPTION

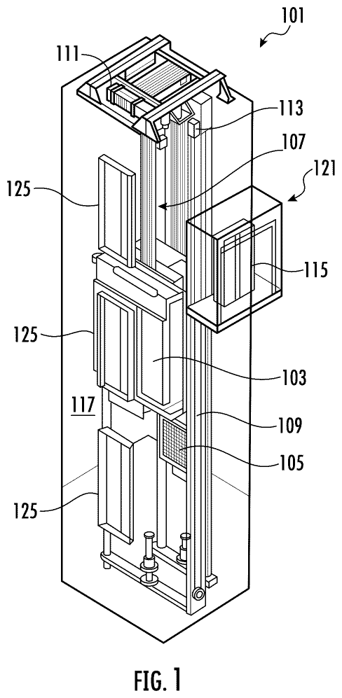

FIG. 1 is a perspective view of a passenger conveyor system, and in particular an elevator system 101 in a building, including an elevator car 103 (generally, a passenger conveyor), a counterweight 105, a tension member 107, a guide rail (or rail system) 109, a machine (or machine system) 111, a position reference system 113, and an electronic elevator controller (generally, an elevator controller) 115. The elevator controller 115, may be directly connected to the car 103 or located separately in the building, or may be part of an elevator management system (EMS) in a control room in the building, as non-limiting examples. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as is known in the art. For example, without limitation, the position reference system 113 can be an encoder, sensor, or other system and can include velocity sensing, absolute position sensing, etc., as will be appreciated by those of skill in the art.

The elevator controller 115 may be located, as shown, in a controller room 121 of the elevator shaft 117 and is configured to control the operation of the elevator system 101, and particularly the elevator car 103. It is to be appreciated that the elevator controller 115 need not be in the controller room 121 but may be in the hoistway or other location or position in the elevator system 101. In one embodiment, the controller 115 may be located remotely or in the cloud. The elevator controller 115 may provide drive signals to the machine 111 to control the acceleration, deceleration, leveling, stopping, etc. of the elevator car 103. The elevator controller 115 may also be configured to receive position signals from the position reference system 113 or any other desired position reference device. When moving up or down within the elevator shaft 117 along guide rail 109, the elevator car 103 may stop at one or more landings 125 as controlled by the elevator controller 115.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms for moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

Though elevator systems are disclosed in depth herein as a nonlimiting example, the present disclosure is equally applicable to other forms of passenger conveyor systems. Passenger conveyor systems include moving walkways and escalators and other automated people movers as nonlimiting alternatives to elevator systems, all of which move people between and along different levels in a building.

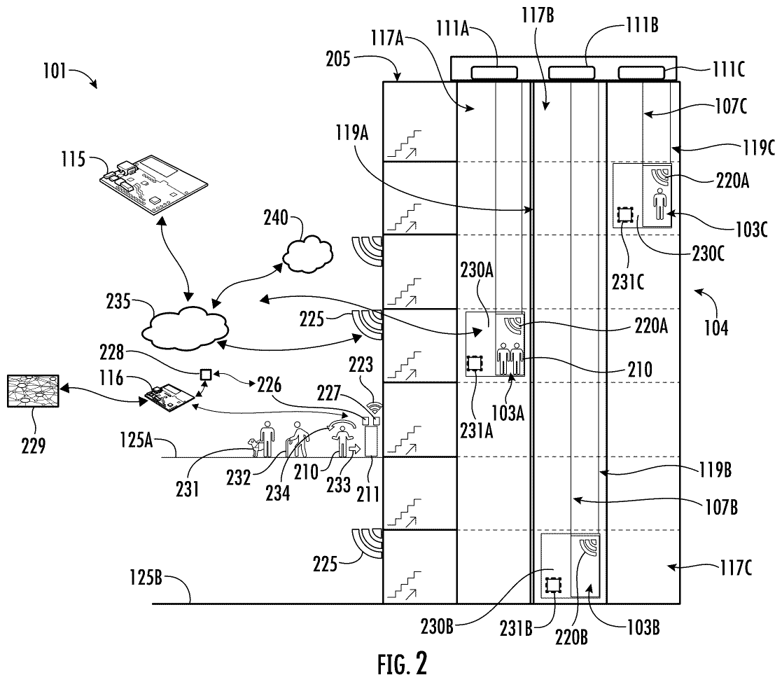

Turning to FIG. 2, additional aspects of the system 110 of FIG. 1 are shown. Within a building 205, the system 101 may have elevator shafts 117A-117C. Within the shafts 117A-117C, a bank of cars 103A-103C (generally a bank 104) are driven by machines 111A-111C via belts 107A-107C to move passengers 210 between floors 125. The passengers 210 may utilize a call station 211 on a first level 125A to request service for transportation to a second level 125B. The cars 103A-103C may be powered, and may communicate with the elevator controller 115, via traveling and hoistway cables (for simplicity, cables) 119A-119C, and may also be powered by onboard batteries 231A-231C. The cars 103A-103C may also communicate wirelessly over a network 235, which may include a cloud service 240, with the elevator controller 115 via communication access points 225. The cars 103A-103C have doors 230A-230C and sensors 220A-220C which may communicate via wired or wireless communications with the elevator controller 115. The sensors 220A-220C may sense velocity, acceleration, vibration, of the cars 103A-103C, which may be generated by motion of the cars 103A-103C and operation of the doors 230A-230C. From these communications, the elevator controller 115 may track the health of the cars 103A-103C.

As indicated in greater detail below, the system 101 is configured for identifying if a passenger 210 is in the lobby 125A, at the elevator bank 104. If it is determined that the passenger 210 requires assistance to find the call station 211, the call station 211 will emit an audible sound to help the passenger 210 locate the elevator call station 211.

The system 110 includes, in addition to the call station 211 located in the lobby 125A, a device controller 116, which may be the same as or distinct from the elevator controller 115. A proximity sensor 226, operationally coupled to the device controller 116, may be located in the lobby 125A, and configured to generate proximity sensor data 228 utilized by the device controller 116. The proximity sensor 226 may be one or more of a video proximity sensor, a motion detector, LIDAR, or RADAR. A speaker 227, operationally coupled to the device controller 116, may also be located in the lobby 125A. The device controller 116, from the proximity sensor data 228, is configured to detect the presence of a passenger 210. The device controller 116 is configured to determine the passenger 210 requires assistance to locate the call station 211 in the lobby 125A. The device controller 116 is configured to issue an audible sound 223 (or cue) from the speaker 227 to guide the passenger 210 to the call station 211.

In one embodiment, one of the call station 211, the speaker 227 and the proximity sensor 226 includes the device controller 116. For example, the processing performed herein may be via edge computing. The device controller 116 may be distinct from one or more of the call station 211, the speaker 227 and the proximity sensor 226 and communicate utilizing wireless or wired protocols. In one embodiment, the call station 211 includes each of the device controller 116, the proximity sensor 226 and the speaker 227.

In one embodiment, the device controller 116 communicates with a cloud service 240 via a network 235 when executing the processing performed herein. The cloud service 240 may perform partial processing of the data 228, which may be stitched together when analyzed by the cloud service 240 or the device controller 116.

In one embodiment, the device controller 116 is configured to compare the proximity sensor data 228 with prerecorded proximity sensor data 228. From this comparison, the device controller 116 may identify characteristics of the passenger 210, including implements accompanying the passenger (such as a wheelchair, cane, walking stick, or crutches) 210, indicative of the passenger 210 possibly requiring assistance.

In one embodiment, the device controller 116 is configured to apply the proximity sensor data 228 to a trained machine learning model 229. By processing the proximity sensor data 228 via the model 229, the device controller 116 may identify characteristics of the passenger 210, including implements accompanying the passenger 210, indicative of the passenger 210 requiring assistance.

For example, in one embodiment, the device controller 116, with the proximity sensor data 228, is configured to identify characteristics of a guide dog 231 with the passenger 210. In one embodiment, the device controller 116, with the proximity sensor data 228, is configured to identify characteristics of a walking cane 232 with the passenger 210. From these characteristics, the device controller 116 may be configured to determine the passenger 210 requires assistance to locate the call station 211 in the lobby 125A.

The device controller 116, with the proximity sensor data 228, may also be configured to identify characteristics of the passenger 210 loitering in the lobby 125A. From these characteristics, the device controller 116 is configured to determine the passenger 210 requires assistance. For example, the device controller 116, with the proximity sensor data 228, is configured to determine the passenger 210 is moving within the lobby 125A at a speed 233 below a threshold. The device controller 116, with the proximity sensor data 228, may be configured to determine the passenger 210 is moving along one or more predetermined paths 234, such as complete or partial loops, near the call station 211 without utilizing the call station 211.

The audible sound 223 may include a verbal direction to the call station 211 relative to a current location of the passenger 210. The audible sound 223 may include a ping that increases in one or more orders of magnitude and frequency as the passenger 210 moves closer to the call station 211. These are nonlimiting examples of such sounds.

In one embodiment, the system 119, detecting the passenger 210 moving to an elevator car 103 on the lobby 125A, will control the elevator car 103 to remain on the lobby 125A with its doors open until the passenger 210 has boarded.

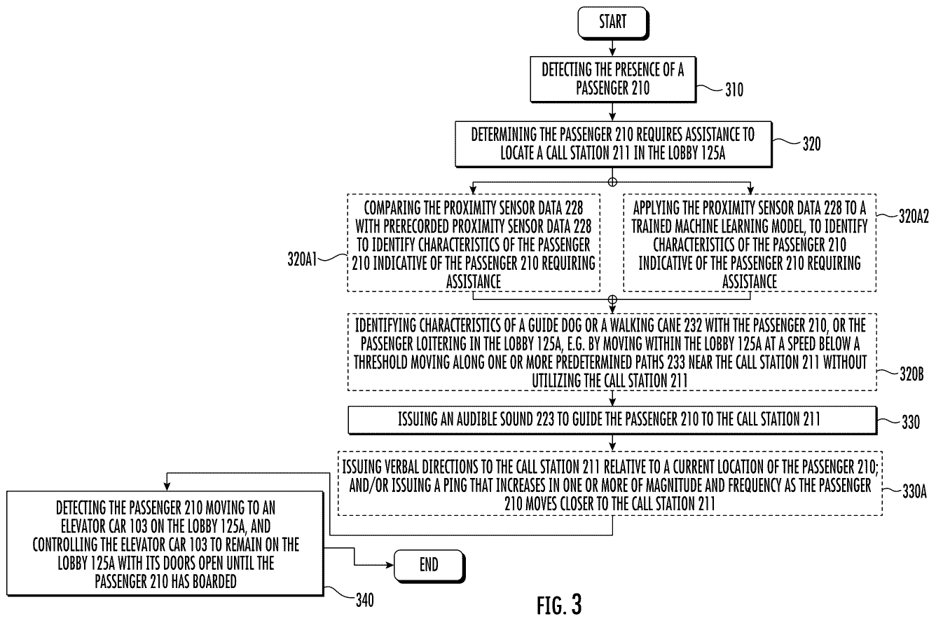

Turning to FIG. 3, a flowchart shows a method of controlling an elevator system 110. In FIG. 3, boxes in dashed lines in the flowchart represent further explanations of one or more preceding steps and are not intended to limit the scope of the embodiments.

As shown in block 310, the method includes detecting, by a device controller 116 that receives proximity sensor data 228 from a proximity sensor 226, which is operationally coupled to the device controller 116 and located in the lobby 125A, the presence of a passenger 210.

As shown in block 320, the method includes determining, by the device controller 116, the passenger 210 requires assistance to locate a call station 211 in the lobby 125A.

As shown in block 320A1, when determining the passenger 210 requires assistance to locate the call station 211 in the lobby 125A, the method includes comparing, by the device controller 116, the proximity sensor data 228 with prerecorded proximity sensor data 228. From this comparison, the device controller 116 identifies characteristics of the passenger 210, including implements accompanying the passenger 210, indicative of the passenger 210 requiring assistance.

As shown in block 320A2, when determining the passenger 210 requires assistance to locate the call station 211 in the lobby 125A, the method includes applying, by the device controller 116, the proximity sensor data 228 to a trained machine learning model. By applying the model 119, the device controller 116 may identify characteristics of the passenger 210, including implements accompanying the passenger 210, indicative of the passenger 210 requiring assistance. The model 119 may be trained on legacy data in which such characteristics were identified.

As shown in block 320B, when determining the passenger 210 requires assistance to locate the call station 211 in the lobby 125A, the method includes identifying, by the device controller 116 from the proximity sensor data 228, characteristics of a guide dog or a walking cane 232 with the passenger 210, or the passenger loitering in the lobby 125A. Characteristics of loitering include, for example, the passenger 210 moving within the lobby 125A at a speed 233 below a threshold or moving along one or more predetermined paths 234 near the call station 211 without utilizing the call station 211.

As shown in block 330, the method includes issuing, by a speaker 227, which is operationally coupled to the device controller 116 and located in the lobby 125A, an audible sound 223 to guide the passenger 210 to the call station 211. As shown in block 330A, when issuing the audible sound 223 to guide the passenger 210 to the call station 211, the method includes issuing, by the speaker 227, verbal directions to the call station 211 relative to a current location of the passenger 210, and/or issuing, by the speaker 227, a ping that increases in one or more of magnitude and frequency as the passenger 210 moves closer to the call station 211.

As shown in block 340, the method includes the system 119 detecting the passenger 210 moving to an elevator car 103 on the lobby 125A, and controlling the elevator car 103 to remain on the lobby 125A with its doors open until the passenger 210 has boarded.

As indicated, the embodiments provide a proximity sensor 226, which may be a camera or motion detection device, with a speaker 227 configured to emit an audible sound, which may be a low decibel audible sound, when a passenger 210 requiring assistance is detected. The proximity sensor 226 is affixed in a location immediately adjacent to, or integrated onto, the call station 211. Machine learning may be implemented so that a device controller 116 communicating with the proximity sensor 226 is configured to detect implements such as a walking cane 232 and a guide dog 231, that accompany a passenger 210, and to emit audible sounds 223 when these are present. Further, a machine learning model 229 may be trained to detect passengers 210 that may require assistance by analyzing motion patterns and behaviors, including but not limited to their speed 233 and moving path 234, in comparison to the training data representing historical passenger activities. Depending on the behavior of the passenger 210, a volume of audible sounds 223 may increase and/or detailed verbal instructions may be provided to guide the passenger 210 to the call station 211.

With the embodiments, a passenger who is blind or visually impaired 210 may more readily find a call station 211 at an elevator bank 104. This solution could be retrofitted within existing systems to increase accessibility, without requiring more extensive upgrades to the interface of the call station 211.

Regarding the implementation of artificial intelligence (AI) identified herein, expressly or inherently, a machine learning model, e.g., part of an artificial intelligence (AI) system, may be utilized in the embodiments. An AI system simulates human intelligence using a digital computer or a machine controlled by a digital computer, senses the environment, e.g., using available proximity sensors including speed, acceleration, vibration, sound, video and the like, and acquires knowledge and uses the knowledge to obtain the optimum results. The AI infrastructure includes technologies such as the proximity sensors, dedicated artificial intelligence chips, cloud computing, distributed storage, big data processing technologies, operation/interaction systems, mechatronics, and the like. Some implementations of AI according to the embodiments utilize computer vision technology, a voice processing technology, a natural language processing technology, machine learning/deep learning and the like.

Some implementations of AI according to the embodiments utilize pre-trained (PT) machine translation models that adopt a sequence-to-sequence (sequence-sequence or S-S) framework based on a neural network. The S-S framework is a framework including an encoder-decoder structure. The encode-decoder structure converts an input sequence into another sequence output. In this framework, the encoder converts the input sequence into vectors, and the decoder accepts the vectors and generates the output sequence in time order. The encoder and the decoder may utilize the same type of neural network model, or may utilize different types of neural network models. The neural network model may be a CNN (Convolutional Neural network) model, an RNN (redundant Neural network) model, a long-short-term memory (LSTM) model, a delay network model, a gated CNN model, or the like.

The trained machine learning models, once trained, can analyze the input data, and in one or more aspects, predict and/or characterize features included in the sensed data. In the case of video, in one non-limiting example, the sensed data can include sequential images and/or encoded video data (e.g., using digital video file/stream formats and/or codecs, such as MP4, MOV, AVI, WEBM, AVCHD, OGG, and/or the like including combinations and/or multiples thereof). The prediction and/or characterization of the features can include segmenting the video data. In some instances, the one or more trained machine learning models include or are associated with a preprocessing or augmentation (e.g., intensity normalization, resizing, cropping, and/or the like including combinations and/or multiples thereof) that is performed prior to segmenting the video data. An output of the one or more trained machine learning models can include a prediction of aspects of the video data, a location and/or position of the aspects within the video data, and/or state of the aspects. The location can be a set of coordinates in an image/frame in the video data. The trained machine learning models, in one or more examples, are trained to perform higher-level predictions and tracking.

Similar predictions can be made with regard to the operational state of a device by analyzing proximity sensor data captured while the device is utilized and applying the data to trained machine learning models. For example, utilizing a serviced learning technique, the model is trained on known inputs and outputs from legacy events to predict future outputs from future inputs. The models may be evaluated so that variables may be weighted or re-weighted to more accurately correlate inputs and outputs, and the model may be re-retrained as more inputs and outputs are collected. For example, the prediction of a state of multiple devices of an operationally integrated system of devices may be obtained utilizing a trained model. Data may be captured, including operational sounds, vibrations, etc., for one (or fewer than all) of the devices, and the captured data may be run through a trained model that is trained to identify the influence (constructive and destructive) that the devices have on each other in their respective operational states, including when they are functioning within and outside of acceptable tolerances.

Wireless connections identified above may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHZ, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections identified above may include connections (cables/interfaces) under RS (recommended standard)422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a sever/client protocol designed for use with its programmable logic device controller 116s (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Device controller 116 Area Network (CAN) bus. A CAN is a vehicle bus standard that allows microdevice controller 116s and devices to communicate with each other in applications without a host computer. CAN is a message-based protocol released by the International Organization for Standards (ISO). The above is not intended on limiting the scope of applicable wired technologies.

As indicated, when data is transmitted over a network between end processors, the data may be transmitted in raw form or may be processed in whole or part at any one of the end processors or an intermediate processor, e.g., at a cloud service or other processor. The data may be parsed at any one of the processors, partially or completely processed or compiled, and may then be stitched together or maintained as separate packets of information.

Each processor identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random-access memory (RAM), read only memory (ROM), or other electronic, optical, magnetic or any other computer readable medium. Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

What is claimed is:

1. An elevator system, comprising:
a call station located in a lobby;
a device controller;
a proximity sensor, operationally coupled to the device controller, located in the lobby, and configured to generate proximity sensor data utilized by the device controller,
a speaker, operationally coupled to the device controller, and located in the lobby,
wherein the device controller, from the proximity sensor data, is configured to:
detect the presence of a passenger;
determine the passenger requires assistance to locate the call station in the lobby; and
issue an audible sound from the speaker to guide the passenger to the call station.

2. The system of claim 1, wherein the system is configured to detect the passenger moving to an elevator car at the lobby, and to control the elevator car to remain at the lobby, with elevator doors opened until the passenger has boarded the elevator car.

3. The system of claim 1, wherein the call station includes the device controller, the proximity sensor and the speaker.

4. The system of claim 1, wherein the proximity sensor is one or more of:
a video proximity sensor; a motion detector; LIDAR; or RADAR.

5. The system of claim 1, wherein the device controller is configured to:
compare the proximity sensor data with prerecorded proximity sensor data to identify characteristics of the passenger, including implements accompanying the passenger, to determine the passenger requires assistance to locate the call station in the lobby.

6. The system of claim 1, wherein the device controller is configured to:
apply the proximity sensor data to a trained machine learning model, to identify characteristics of the passenger, including implements accompanying the passenger, to determine the passenger requires assistance to locate the call station in the lobby.

7. The system of claim 5, wherein the device controller, with the proximity sensor data, is configured to determine the passenger requires assistance to locate the call station in the lobby by:
identifying characteristics of a guide dog with the passenger; and/or
identifying characteristics of a walking cane with the passenger.

8. The system of claim 5, wherein the device controller, with the proximity sensor data, is configured to identify characteristics of the passenger loitering in the lobby and thereby determine the passenger requires assistance to locate the call station in the lobby.

9. The system of claim 8, wherein the device controller, with the proximity sensor data, is configured to determine the passenger is loitering in the lobby by:
determining the passenger is moving within the lobby at a speed below a threshold; or
determine the passenger is moving along one or more predetermined paths near the call station without utilizing the call station.

10. The system of claim 9, wherein the audible sound includes:
verbal directions to the call station relative to a current location of the passenger; and/or
a ping that increases in one or more of magnitude and frequency as the passenger moves closer to the call station.

11. A method of controlling an elevator system, comprising:
detecting, by a device controller that receives proximity sensor data from a proximity sensor, which is operationally coupled to the device controller and located in a lobby, the presence of a passenger;
determining, by the device controller, the passenger requires assistance to locate a call station in the lobby; and
issuing, by a speaker, which is operationally coupled to the device controller and located in the lobby, an audible sound to guide the passenger to the call station.

12. The method of claim 11, comprising the system detecting the passenger moving to an elevator car at the lobby, and controlling the elevator car to remain at the lobby, with elevator doors opened until the passenger has boarded the elevator car.

13. The method of claim 11, wherein the call station includes the device controller, the proximity sensor and the speaker.

14. The method of claim 11, wherein the proximity sensor is one or more of:
a video proximity sensor; a motion detector; LIDAR; or RADAR.

15. The method of claim 11, wherein when determining the passenger requires assistance to locate the call station in the lobby, the method includes:
comparing, by the device controller, the proximity sensor data with prerecorded proximity sensor data to identify characteristics of the passenger, including implements accompanying the passenger.

16. The method of claim 11, wherein when determining the passenger requires assistance to locate the call station in the lobby, the method includes:
applying, by the device controller, the proximity sensor data to a trained machine learning model, to identify characteristics of the passenger, including implements accompanying the passenger, to determine the passenger requires assistance to locate the call station in the lobby.

17. The method of claim 15, wherein when determining the passenger requires assistance to locate the call station in the lobby, the method includes:
identifying, by the device controller from the proximity sensor data, characteristics of a guide dog with the passenger; and/or
identifying, by the device controller from the proximity sensor data, characteristics of a walking cane with the passenger.

18. The method of claim 15, wherein when determining the passenger requires assistance to locate the call station in the lobby, the method includes:
identifying, by the device controller from the proximity sensor data, characteristics of the passenger loitering in the lobby.

19. The method of claim 18, wherein when determining the passenger is loitering in the lobby, the method includes:
determining, by the device controller from the proximity sensor data, that the passenger is moving within the lobby at a speed below a threshold; or
determining, by the device controller from the proximity sensor data, that the passenger is moving along one or more predetermined patterns near the call station without utilizing the call station.

20. The method of claim 19, wherein when issuing the audible sound to guide the passenger to the call station, the method includes:
issuing, by the speaker, verbal directions to the call station relative to a current location of the passenger; and/or
issuing, by the speaker, a ping that increases in one or more of magnitude and frequency as the passenger moves closer to the call station.
